(19) United States
(12) Patent Application Publication
(10) Pub. No.: US 2024/0229374 A9
(43) Pub. Date: Jul. 11, 2024

(54) PRESSURE SENSOR FOR A SCREED PLATE APPARATUS

(71) Applicant: AXENOX, LLC., Powell, WY (US)

(72) Inventors: Stuart Anthony FROST, Powell, WY (US); David Michael FROST, JR., Powell, WY (US)

(21) Appl. No.: 18/276,813

(22) PCT Filed: Feb. 22, 2022
(86) PCT No.: PCT/US22/17361

§ 371 Date: Aug. 10, 2023

Related U.S. Application Data
(60) Provisional application No. 63/152,629, filed on Feb. 23, 2021.

(51) Int. Cl. E01C 19/48; G01G 19/08

(52) U.S. Cl. CPC E01C 19/4873; G01G 19/08; E01C 2301/10; E01C 2301/30

(57) ABSTRACT

A screed system includes a screed plate and a plurality of pressure sensors coupled to the screed plate and configured to sense a weight of the screed plate. A method for positioning screed system includes receiving pressure information from a plurality of pressure sensors engaged with a screed plate; determining a pressure distribution across the screed plate based on the pressure information; determining, based on the determined pressure distribution across the screed plate, an angle of attack of the screed plate; and adjusting the angle of attack of the screed plate.

### RELATED APPLICATIONS

This application claims the benefit of U.S. Provisional Patent Application No. 63/152,629, filed Feb. 23, 2021 and hereby incorporates by reference herein the contents of this application.

### TECHNICAL FIELD

Aspects of the disclosure are directed to systems and methods for determining a position of a screed plate of a road paver and repositioning the screed plate based on the determined position.

### BACKGROUND

Road pavers are used to apply a paving material, such as hot mix asphalt or concrete, to surfaces at sites such as highways, airports, roads, and construction sites. The paving material is typically loaded in front of a tractor of the road paver, typically in a hopper, and conveyed to the rear by a set of flight feeders (conveyor belts), where the paving material is spread to a desired width by a set of augers in the road paver, and then leveled and compacted by a screed system. The screed system is typically towed behind the tractor of the paver. A hydraulic arm may be coupled between the tractor and a tow arm of the screed system to control an angle between the paving surface and the screed plate of the screed system. The screed plate is typically heated so as to effectively spread, level, and compress the paving material across the surface being paved. Maintaining a proper angle of the screed plate relative to the surface being paved is an important factor in ensuring that the paving material is properly applied and that the screed plate does not exhibit undue wear.

Typically, the angle of the screed plate relative to the surface to be paved may be set manually by an operator of the road paver at the beginning of a paving operation. For example, the operator may set the angle using manual depth screws or by controlling a position of the hydraulic arm between the tractor and the screed system. The operator does not typically monitor or reset the angle between the screed plate and the surface being paved during the paving operation. As noted above, this can lead to undue wear of the screed plate or cause the paved surface not to be ideal.

### SUMMARY

The following presents a simplified summary of one or more aspects of the disclosure in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects of the disclosure in a simplified form as a prelude to the more detailed description that is presented later.

According to some aspects, the present disclosure is directed to a screed system including a screed plate and a plurality of pressure sensors coupled to the screed plate and configured to sense a weight of the screed plate.

According to some aspects, the present disclosure is directed to a computer-implemented method for positioning a screed system configured to engage a road paver. The method includes receiving pressure information from a plurality of pressure sensors engaged with a screed plate. The method includes determining a pressure distribution across the screed plate based on the pressure information. The method includes determining, based on the determined pressure distribution across the screed plate, an angle of attack of the screed plate. The method includes adjusting the angle of attack of the screed plate.

To the accomplishment of the foregoing and related ends, the one or more aspects of the disclosure comprise the features hereinafter fully described and particularly pointed out in the claims. The following description and the annexed drawings set forth in detail include certain illustrative features of the one or more aspects. These features are indicative, however, of but a few of the various ways in which the principles of various aspects can be employed, and this description is intended to include all such aspects and their equivalents.

### BRIEF DESCRIPTION OF THE DRAWINGS

The novel features believed to be characteristic of aspects described herein are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objects and advances thereof, will be best understood by reference to the following detailed description of illustrative embodiments when read in conjunction with the accompanying drawings, wherein:

FIG. 1 illustrates a side view of a road paver according to an aspect of the disclosure;

FIG. 2 illustrates a detail view of a screed system of the road paver of FIG. 1 according to some aspects of the disclosure;

FIG. 3 illustrates the screed system of FIG. 2 with a housing removed, according to an aspect of the disclosure;

FIG. 4 illustrates the screed system of FIG. 3 with further housings removed, according to an aspect of the disclosure;

FIG. 5 illustrates a detail view of pressure sensors engaged with a screed plate of the screed system of FIG. 4, according to an aspect of the disclosure;

FIG. 6 illustrates a side view of the screed system of FIG. 3, according to an aspect of the disclosure;

FIG. 7 illustrates a top view of the screed system of FIG. 3, according to an aspect of the disclosure;

FIG. 8 illustrates an example system diagram of various hardware components and other features for use in accordance with aspects of the disclosure; and

FIG. 9 illustrates an example flowchart of a method for monitoring an angle of attack of the screed plate and/or a pressure distribution across the screed plate during a paving operation, according to an aspect of the disclosure.

### DETAILED DESCRIPTION

The detailed description set forth below in connection with the appended drawings is intended as a description of various configurations and is not intended to represent the only configurations in which the concepts described herein can be practiced. The detailed description includes specific details for the purpose of providing a thorough understanding of various concepts. However, it will be apparent to those skilled in the art that these concepts can be practiced without these specific details. In some instances, well known structures and components are shown in block diagram form in order to avoid obscuring such concepts.

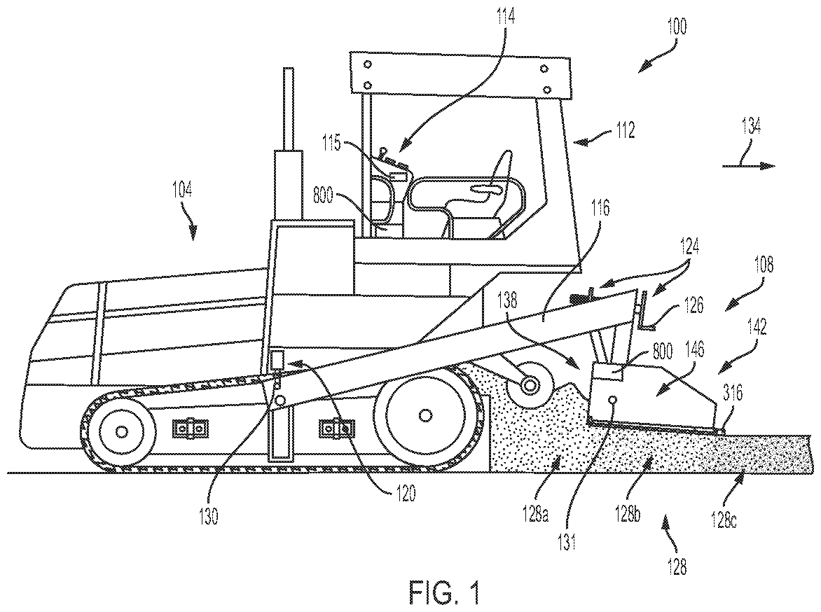

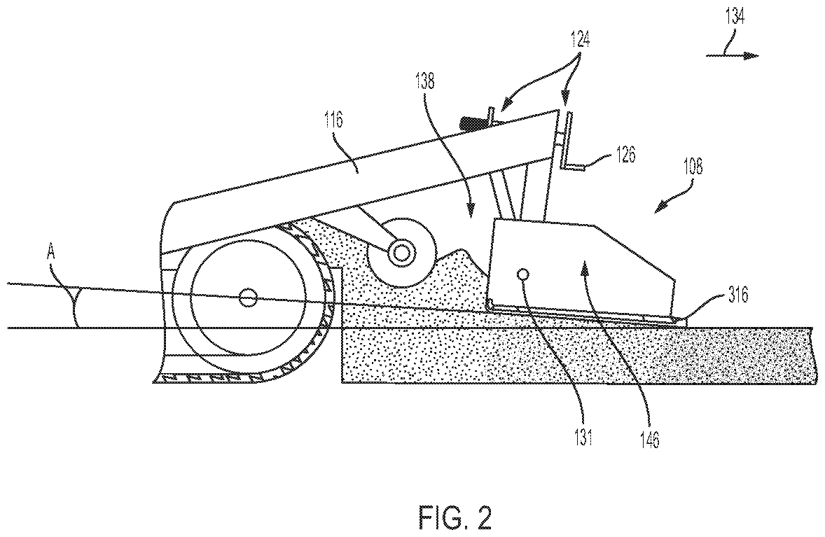

FIGS. 1 and 2 illustrate a road paver 100 according to an aspect of the present disclosure. The road paver 100 includes a tractor 104 and a screed system 108. The tractor 104 may include a hopper, a conveyor system, and an operator cabin 112 that includes operation controls 114. The operator may use the operation controls 114 to drive the road paver 100, actuate various features of the road paver 100, and so forth. The operation controls 114 may include an operator input/output (I/O) interface 115 and the computing system 800. The operator I/O interface 115 may include input devices such as levers, joysticks, keyboards, voice command inputs, and so forth that allow the operator to input commands or information to the road paver 100. The operator I/O interface 115 may include output devices such as screens, LED indicator lights, auditory alarms, and so forth that are configured to provide information to the operator regarding operation of the road paver 100.

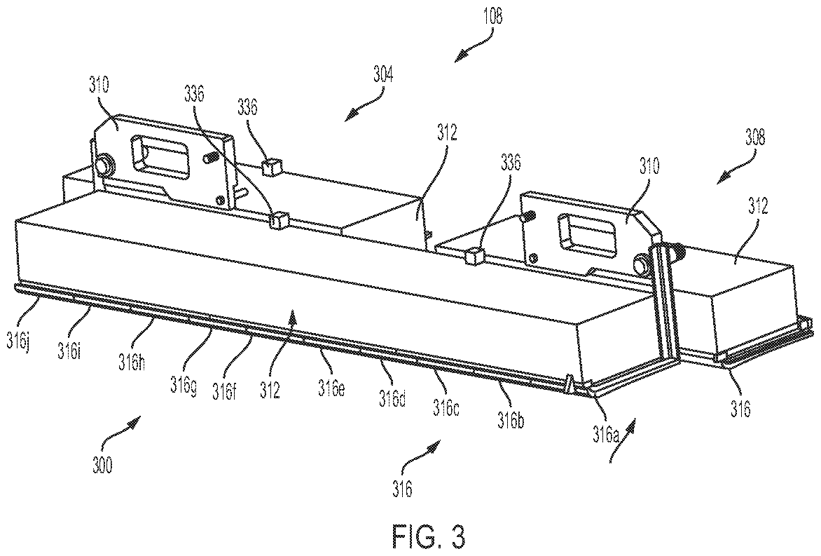

The tractor 104 may be coupled to the screed system 108 via one or more tow arms 116. A hydraulic cylinder 120 may be engaged with the tow arm 116 at a tow point 130 to adjust a position of the screed system 108 relative to the surface to be paved. For example, the hydraulic cylinder 120 may be used to change an angle of attack A of a screed plate 316 (FIGS. 3-6). As used herein, the phrase “angle of attack” refers to an angle between the screed plate 316 and the surface to be paved, as shown in FIG. 2. A setting pin 124 may be coupled between the tow arm 116 and the screed system 108. The setting pin 124 may be actuated by an operator (e.g., via the handle 126) to further adjust the angle A between the screed plate 316 and the surface to be paved.

During paving, the paving material 128 is fed from the hopper via the conveyor system in a direction shown by arrow 134 and deposited in front of a front end 138 of the screed system 108. The screed plate 316 of the screed system is configured to spread and compact the paving material along the surface to be paved. As shown schematically at section 128a, the paving material 128 is at its loosest (e.g., least dense, least compact, least level) proximate the front end of the screed system 108. The paving material 128 becomes less loose (e.g., denser, more compact, more level) as the screed system 108 slides over the paving material 128, as shown schematically at 128b. The paving material 128 is most compact proximate a rear end 141 of the screed system 108, as shown schematically at 128c. The angle of attack A impacts both the density and the grade of the paving material. In some aspects of the disclosure, the angle of attack A may be between 2° and 5°.

FIGS. 3-7 illustrate the screed system 108 according to some aspects of the disclosure. FIGS. 3-7 illustrates the screed system 108 with a housing 146 of the screed system 108 removed. As illustrated in FIG. 3, the screed system 108 includes a first screed unit 300, a second screed unit 304, a third screed unit 308, and a frame 310. The frame 310 may be configured to mount the housing 146 over the screed units 300, 304, 308. In some aspects, the screed unit 300 may be stationary relative to the screed system 108. In some aspects, the second screed unit 304 and the third screed unit 308 may be extended or retracted relative to the first screed unit 300. In other aspects of the disclosure, the screed system 108 may include more or fewer screed units. The first screed unit 300, the second screed unit 304, and the third screed unit 308 are substantially similar so only the first screed unit 300 is described in detail herein. Corresponding parts between the first screed unit 300, the second screed unit 304, and the third screed unit 308 are shown using like numbers.

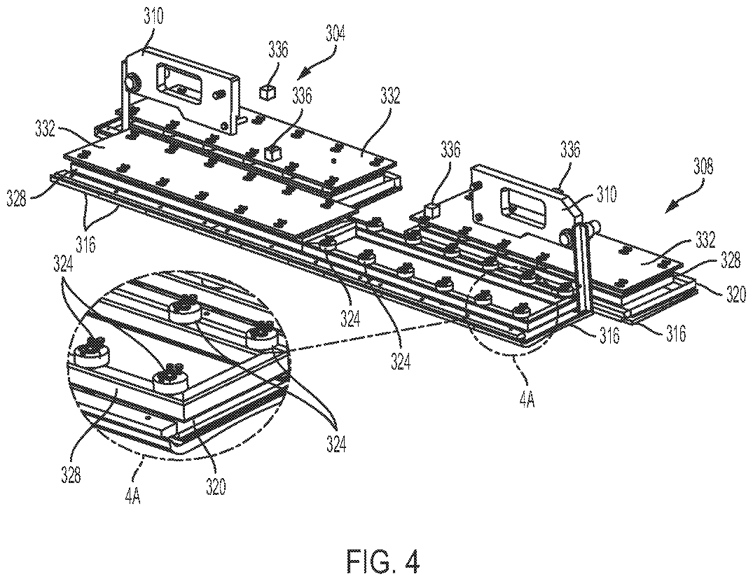

As best shown in FIGS. 3 and 4, the screed unit 304 may include a housing 312, a screed plate 316, a mounting plate 320 having heating elements (not shown), a plurality of pressure sensors 324, support walls 328, a support plate 332, and an indicator 336. The screed plate 316 may be configured to engage the paving material 128 dispensed from the road paver 100 so as to spread and level the paving material 128 along the surface to be paved. In some aspects of the disclosure, the bottom surface (e.g., the surface configured to contact the paving material) may include a pattern or a texture, such as a repetitive wave form pattern, a repetitive v-shaped pattern, a repetitive block shaped pattern, or a variably shaped wave pattern. In some aspects of the disclosure, the screed plate 316 may include a plurality of modular screed plates 316a, 316b . . . 316j, as illustrated in FIG. 3. In other aspects of the disclosure, the screed plate 316 may be a single screed plate. The mounting plate 320 having the heating elements may be coupled to the screed plate 316 and is configured to heat the screed plate 316. Heating the screed plate 316 prevents hot paving material from sticking to the screed plate 316 as well as maintaining a raised temperature during paving so as to not prematurely cool the paving material 128. In some aspects of the disclosure, the heating elements may be electric heating elements that are powered by a power source of the tractor 104.

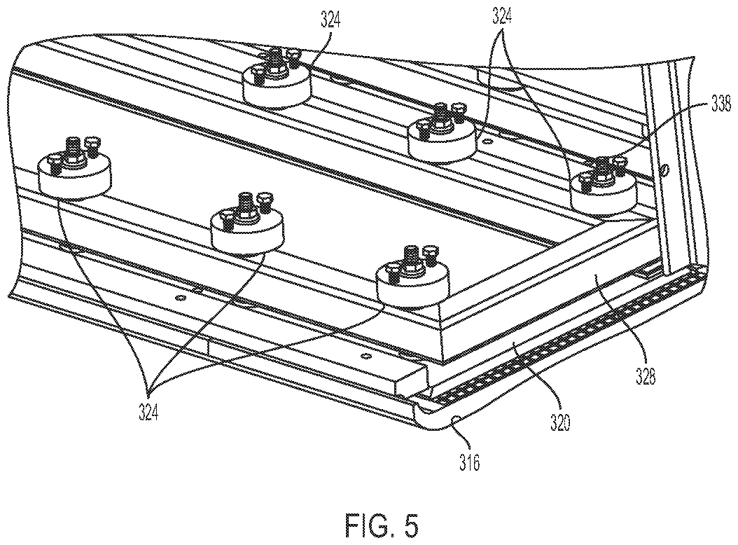

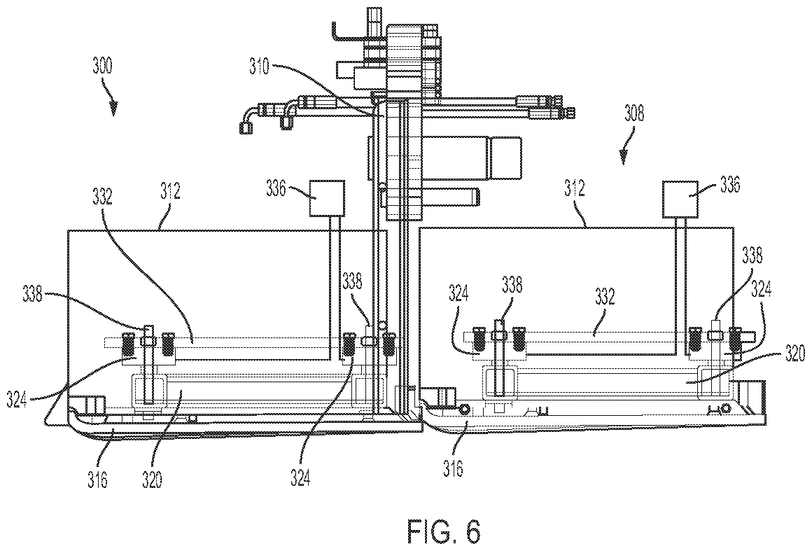

As is best shown in FIGS. 5 and 6 and inset 4A in FIG. 4, the mounting plate 320 may be coupled to the support walls 328 and the support plate 332 by a plurality of bolts 338. The screed plate 316 can also be coupled to the support walls 328 by the plurality of bolts 338, or the screed plate 316 can be releasably secured to the mounting plate 320. A plurality of springs (not shown) may be positioned between the screed plate 316 and the support plate 332 so that the screed plate 316 may float above the paving material. A plurality of pressure sensors 324 may be coupled between the screed plate 316 and the support plate 332. In some aspects of the disclosure, the pressure sensors 324 may be positioned between the housing 312 and the frame 310. In some aspects of the disclosure, the pressure sensors 324 may be engaged with the bolts 338. The pressure sensors 324 may be configured to sense a pressure indicative of a weight of the screed plate 316. In some aspects of the disclosure, the pressure sensors 324 may be positioned in other locations above the screed plate 316. For example, the pressure sensors 324 may be positioned above or below the support plate 332, the frame 310, and so forth. In aspects that include the heating elements, the pressure sensors 324 may be positioned above the screed plate 316 and the mounting plate 320, which includes the heating elements. The pressure sensors 324 may be configured to transmit pressure information to the computing system 800.

As described in greater detail below, the computing system 800 may be configured to determine a weight or pressure distribution of the screed plate 316 based on the pressure sensed by the pressure sensors 324. The computing system 800 may then be configured to determine the angle of attack A of the screed plate 316 based on the pressure distribution of the screed plate 316. In some aspects of the disclosure, the pressure sensors 324 may include load cells, strain gauge pressure sensors, potentiometric pressure sensors, inductive pressure sensors, capacitive pressure sensors, piezoelectric pressure sensors, variable reluctance pressure sensors, and/or one or more hydraulic pistons with coupled to a hose that is in turn coupled to an electronic pressure gauge. The computing system 800 may be configured to change the angle of attack A based on the pressure distribution of the screed plate 316 during paving. In some aspects, the computing system may be configured to dynamically change the angle of attack A in real-time or substantially real-time during paving.

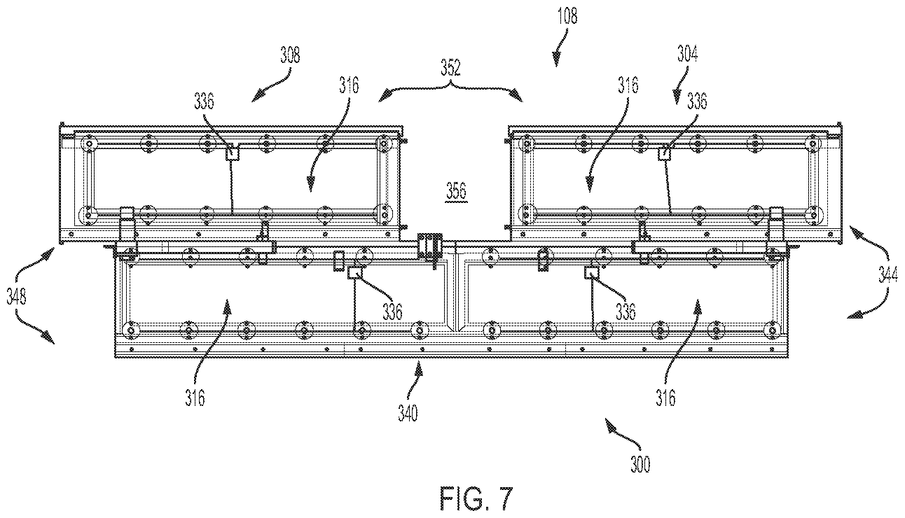

FIG. 7 illustrates a top view of the screed system 108 with the housing 146 removed. As is best shown in FIG. 7, in some aspects of the disclosure, the pressure sensors 324 may be positioned to determine at least a pressure at or proximate a right side 344 of the screed system 108, a pressure at or proximate a left side 348 of the screed system 108, a pressure at or proximate a front side 340 of the screed system 108, and a pressure at or proximate a rear side 352 of the screed system 108. In some aspects of the disclosure, the pressure sensors 324 may also be positioned to determine at least a pressure at or proximate a center 356 of the screed system 108. In some aspects of the disclosure, the pressure sensors 324 may be positioned to determine at least a pressure at or proximate the front side of the screed plate 316 and a pressure at or proximate the rear side 352 of the screed system 108. In some aspects of the disclosure, the pressure sensors 324 may be positioned to determine at least a pressure at or proximate a first side of the screed plate 316 and a pressure at or proximate a second side of the screed plate 316. In such aspects, the second side is opposite the first side.

As is described in greater detail below, a computer system 800 may generate a screed plate repositioning control signal configured to reposition the screed system 108 based on the pressure determined by the pressure sensors 324. For example, the computer system 800 may command an actuator such as the hydraulic cylinder 120 to reposition the tow arms 116 in response to the determined pressure indicating that the pressure at or proximate the front side 340 or the rear side 352 of the screed system 108 exceeds a predefined pressure threshold. In another example, the computer system 800 notify the operator, via the I/O interface 115, that the pressure of second screed unit 304 are the third screed unit 308 different in response to determining that the pressure at the second screed unit 304 is different than the pressure at the third screed unit 308. The notification may prompt the operator to reposition the second screed unit 304 or the third screed unit 308 so that the pressures of the second and third screed units 304, 308 are similar. In yet another example, the computer system 800 may notify the operator, via the operator I/O interface 115, that the pressure of the second and third screed units 304, 308 is greater than the pressure at the first screed unit 300. The notification may prompt the operator to lift the second screed unit 304 or the third screed unit 308 so that the pressures of the first, second, and third screed units 300, 304, 308 are similar.

In some aspects of the disclosure, the indicator 336 may be coupled to the pressure sensors 324. The indicator may be configured to display information indicative of a status of the screed plate 316 to the operator. For example, the indicator 336 may be a LED indicator configured to light up or turn color in response to determining that the screed plate 316 should likely be repositioned, an audio indicator configured to emit an alarm sound in response to determining that the screed plate 316 should likely be repositioned, and so forth. In another example, the indicator 336 may be a screen configured to illustrate the actual pressures determined by the pressure sensors 324, an animation illustrating the pressure distribution across the screed plate 316, an indication that the determined pressures are within limits, out of limits (e.g., that the screed plate 316 should be repositioned), and so forth. In some aspects of the disclosure, the indicator 336 may be represented in a user interface or user control panel in the operator cabin 112 of the road paver 100 so that the operator can adjust the angle of attack A based on the readings from the indicators 336.

Although the indicator 336 is described with respect to the screed plate 316, the indicator 336 may also display similar information with respect to each of the screed units 300, 304, 308. In some aspects of the disclosure, the indicator 336 may display a notification may prompt the operator to reposition the second screed unit 304 or the third screed unit 308 as described above.

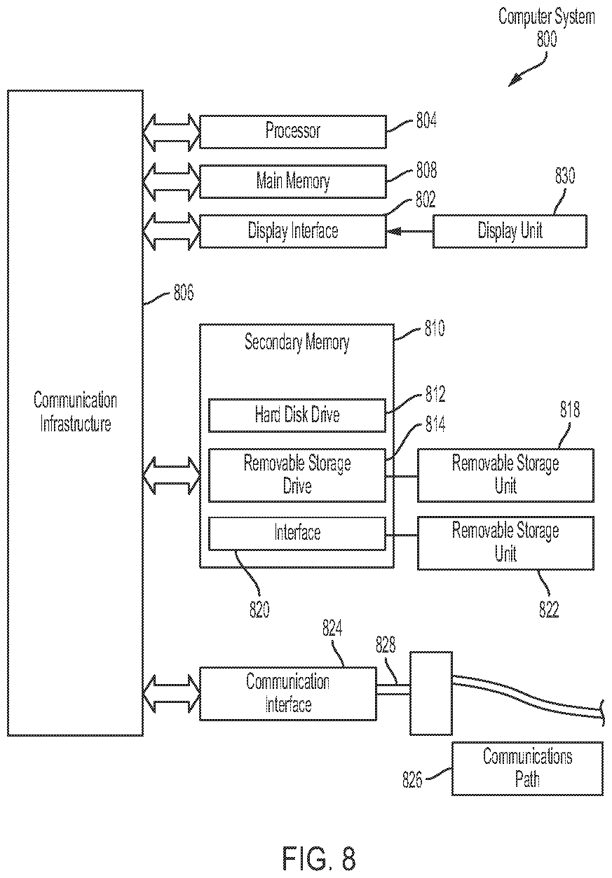

Aspects of the disclosure may be implemented using hardware, software, or a combination thereof and may be implemented in one or more computer systems or other processing systems. In one aspect, the disclosure is directed toward one or more computer systems capable of carrying out the functionality described herein. FIG. 8 presents an example system diagram of various hardware components and other features that may be used in accordance with aspects of the disclosure. Aspects of the disclosure may be implemented using hardware, software, or a combination thereof and may be implemented in one or more computer systems or other processing systems. In one example variation, aspects of the disclosure are directed toward one or more computer systems capable of carrying out the functionality described herein. An example of such a computer system 800 is shown in FIG. 8. In some aspects of the disclosure, the computer system 800 may be positioned in the operator cabin 112. In some aspects of the disclosure, the computer system 800 may be positioned within the screed system 108.

The computer system 800 includes one or more processors, such as a processor 804. The processor 804 is connected to a communication infrastructure 806 (e.g., a communications bus, cross-over bar, or network). Various software aspects are described in terms of this example computer system. After reading this description, it will become apparent to a person skilled in the relevant art(s) how to implement aspects of the disclosure using other computer systems and/or architectures.

The computer system 800 may include a display interface 802 that forwards graphics, text, and other data from the communication infrastructure 806 (or from a frame buffer not shown) for display on a display unit 830. The computer system 800 also includes a main memory 808, preferably random access memory (RAM), and may also include a secondary memory 810. The secondary memory 810 may include, for example, a hard disk drive 812 and/or a removable storage drive 814, representing a floppy disk drive, a magnetic tape drive, an optical disk drive, etc. The removable storage drive 814 reads from and/or writes to a removable storage unit 818 in a well-known manner. The removable storage unit 818, represents a floppy disk, magnetic tape, optical disk, etc., which is read by and written to removable storage drive 814. As will be appreciated, the removable storage unit 818 includes a computer usable storage medium having stored therein computer software and/or data.

In alternative aspects, the secondary memory 810 may include other similar devices for allowing computer programs or other instructions to be loaded into computer system 800. Such devices may include, for example, a removable storage unit 822 and an interface 820. Examples of such may include a program cartridge and cartridge interface (such as that found in video game devices), a removable memory chip (such as an erasable programmable read only memory (EPROM), or programmable read only memory (PROM)) and associated socket, and other removable storage units 822 and interfaces 802, which allow software and data to be transferred from the removable storage unit 822 to the computer system 800.

The computer system 800 may also include a communications interface 824. The communications interface 824 allows software and data to be transferred between the computer system 800 and external devices. Examples of the communications interface 824 may include a modem, a network interface (such as an Ethernet card), a communications port, a Personal Computer Memory Card International Association (PCMCIA) slot and card, etc. Software and data transferred via the communications interface 824 are in the form of signals 828, which may be electronic, electromagnetic, optical or other signals capable of being received by the communications interface 824. These signals 828 are provided to the communications interface 824 via a communications path (e.g., channel) 826. This path 826 carries signals 828 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 880, a hard disk installed in the hard disk drive 870, and signals 828. These computer program products provide software to the computer system 800. Aspects of the disclosure are directed to such computer program products.

Computer programs (also referred to as computer control logic) are stored in the main memory 808 and/or the secondary memory 810. Computer programs may also be received via the communications interface 824. Such computer programs, when executed, enable the computer system 800 to perform various features in accordance with aspects of the disclosure, as discussed herein. In particular, the computer programs, when executed, enable the processor 804 to perform such features. Accordingly, such computer programs represent controllers of the computer system 800.

In variations where aspects of the disclosure are implemented using software, the software may be stored in a computer program product and loaded into the computer system 800 using the removable storage drive 814, the hard drive 812, or the communications interface 820. The control logic (software), when executed by the processor 804, causes the processor 804 to perform the functions in accordance with aspects of the disclosure as described herein. In another variation, aspects are implemented primarily in hardware using, for example, hardware components, such as application specific integrated circuits (ASICs). Implementation of the hardware state machine so as to perform the functions described herein will be apparent to persons skilled in the relevant art(s).

In yet another example variation, aspects of the disclosure are implemented using a combination of both hardware and software.

During operation of the road paver 100, the paving material may be dispensed from the hopper, via the conveyor system, proximate the front 138 of the screed system 108. The screed plate 316 may engage the paving material, and spread, level, and compact the paving material as the screed system 108 travels over the paving material 128. The angle of attack A of the screed plate 316 may determine an amount of compaction (e.g., a density) of the paving material 128, a grade of the paving material 128, etc. The pressure distribution across the screed plate 316 may also determine an amount of compaction of the paving material 128 and the grade of the paving material 128.

Further, the angle of attack A may impact an amount of wear experienced by the screed plate 316. For example, in conditions in which the angle of attack A is too low, excessive wear may occur along or proximate a front edge of the screed plate 316. In conditions in which the angle of attack A is too high, excessive wear may occur along a rear edge of the screed plate 316.

In conventional paving systems, the operator of the paving system typically sets the angle of attack A of the screed plate 316 at the beginning of a paving operation. The operator typically does not adjust the angle of attack A or the pressure distribution along the screed plate 316 during the paving operation. Conventional road pavers and/or screed systems are not configured to determine and/or monitor the angle of attack A or the pressure distribution along the screed plate 316 during a paving operation.

Under some operating conditions, the angle of attack A may change during the paving operation, making the angle of attack A different than a target angle of attack. For example, if the tow arms 116 are positioned so that the tow point 130 is above a pin 131 of the screed system 108, the tow arms 116 may push upward on the screed system 108 and the pressure sensors 324 may read a pressure that is above a threshold at the front of the screed system 108. Under such conditions, it may be desirable to increase the angle of attack A. Likewise, if the tow arms 116 are positioned so that the tow point 130 is below the pin 131 of the screed system 108, the tow arms 116 may pull downward on the screed system 108 and the pressure sensors 324 may read a pressure that is above a threshold at the back of the screed system 108. Under such conditions, it may be desirable to decrease the angle of attack A. In some aspects, the angle of attack A may be dynamically changed in real time or substantially real time.

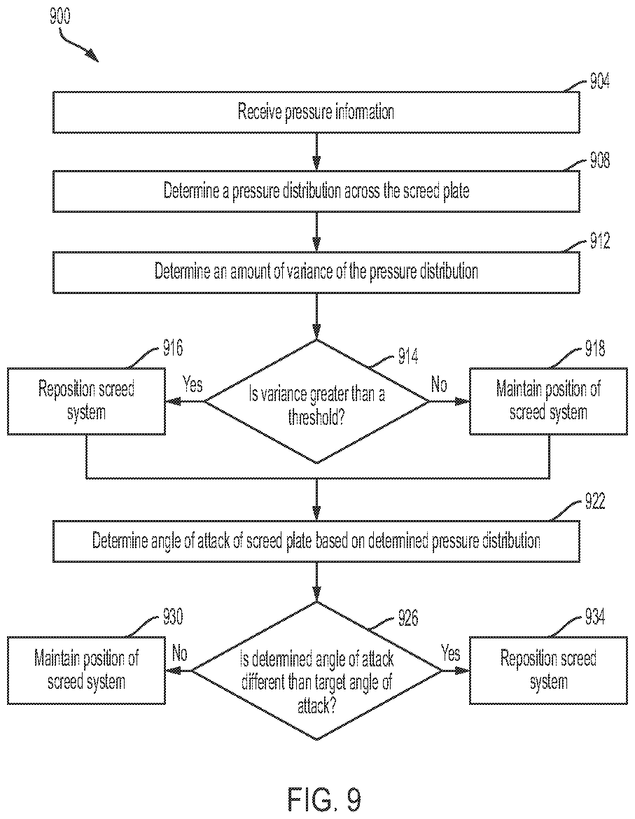

Referring to FIG. 9, therein shown is a flowchart showing an example method 900 for adjusting a position of the screed plate 316 of the road paver 100 during a paving operation of the road paver.

At block 904, the computer system 800 may receive pressure information sensed by each of the pressure sensors 324 coupled to the screed plate 316.

At block 908, the computer system 800 may determine a pressure distribution across the screed plate 316. The determined pressure distribution may be indicative of a weight distribution across the screed plate 316.

At block 912, the computer system 800 may determine an amount of variance across the determined pressure distribution. At block 914, the computer system may compare the determined amount of variance to a difference or variance threshold. In some aspects of the disclosure, the difference or variance threshold may be a value or range of values indicative of a desirable pressure differential between the front and back of the screed plate 316. Variances above the difference or variance threshold may indicate that there is likely too much pressure on the front end or the back end of the screed plate 316. In some aspects of the disclosure, the difference or variance threshold may be a value or range of values indicative of a difference or variance between the pressures of the right side and the left side of the screed plate 316. In some aspects of the disclosure, computer system 800 may use different difference or variance thresholds based on a pattern of the screed plate 316.

In some aspects of the disclosure, the computer system 800 may skip block 912 and compare the determined pressure distribution to a target pressure distribution at block 914. The target pressure distribution may be a pressure distribution or range of pressure distributions indicative of a desirable position of the screed plate 316. In some aspects of the disclosure, the target pressure distribution may be indicative of a desirable pressure differential between the front and back of the screed plate 316. Pressure distributions above the target pressure distribution may indicate that there is too much pressure on the front end or the back end of the screed plate 316. In some aspects of the disclosure, the target pressure distribution may be indicative of a difference or variance between the pressures of the right side and the left side of the screed plate 316. In some aspects of the disclosure, computer system 800 may determine the target pressure distribution based on data from a look-up table that includes information such as a pattern of the screed plate 316, weather conditions, type of paving material, desired thickness and/or density of paving material, plate configuration, and so forth.

In some aspects, the computer system 800 may generate a screed plate repositioning control signal based on the determined pressure distribution. In some aspects, the screed plate repositioning control signal is configured to automatically and dynamically reposition the screed plate based on the determined pressure distribution. For example, at block 916, in response to determining that an amount of pressure in a portion of the screed plate 316 exceeds a difference threshold, the computer system 800 may actuate the hydraulic cylinder 120 to reposition the screed system 108 to reduce the variance of the determined pressure distribution or to bring the determined pressure distribution to or closer to the target pressure distribution. For example, the computing system 800 may determine, based on the determined pressure distribution, that the pressure on the back side of the screed plate 316 is likely too high, which may lead to excessive wear on the back side of the screed plate 316. The computing system 800 may actuate the hydraulic cylinder 120 to decrease the angle of attack A of the screed system 108. In another example, the computing system 800 may determine, based on the determined pressure distribution, that the pressure on the front side of the screed plate 316 is likely too high. The computing system 800 may actuate the hydraulic cylinder 120 to increase the angle of attack A of the screed system 108.

Alternatively, in some aspects of the disclosure, the computer system 800 may display an indication, via the operator I/O interface 115, to the operator that indicates that an amount of pressure in a portion of the screed plate 316 exceeds a difference threshold. In such aspects, the operator may actuate the hydraulic cylinder 120, via the operator I/O interface 115, to reposition the screed system 108 to redistribute pressure along the screed plate 316. In such aspects, the computer system 800 may generate the screed plate repositioning control signal based on the operator input received via the operator I/O interface 115. For example, the computing system 800 may determine, based on the determined pressure distribution, that the second screed unit 304 and the third screed unit 308 are likely not positioned at the same height. The computing system 800 may actuate the hydraulic cylinder 120 to reposition the second and/or third screed units 304, 308. In another example, the computing system 800 may determine, based on the determined pressure distribution, that the pressure second screed unit 304 and the third screed unit 308 are likely positioned lower than the first screed unit 300. The computing system 800 may actuate the hydraulic cylinder 120 to lift the second and/or third screed units 304, 308.

At block 918, in response to determining that the pressure distribution across the screed plate 316 does not exceed the difference threshold, the computer system 800 maintains the configuration of the screed system 108.

At block 922, the computer system 800 may determine the angle of attack of the screed plate 316 based on the determined pressure distribution across the screed plate 316.

At block 926, the computer system 800 may compare the determined angle of attack of the screed plate 316 to a target angle of attack. The target angle of attack may be an angle of attack or a range of angles of attack at which the screed plate 316 is desired to operate. In some aspects of the disclosure, the target angle of attack may be entered by the operator via an operator I/O interface 115. In some aspects of the disclosure, the computer system 800 may be configured to determine the target angle of attack based on a target road grade, information indicative of a grade of the surface to be paved, a type of paving material, desired characteristics of the paved surface, information indicative of weather characteristics during the paving operation, a pattern of the screed plate 316, and so forth. The computer system 800 may determine the target angle of attack via a look-up table, an algorithm, and so forth. Example desired characteristics of the paved surface may include a density, a smoothness, a texture, a grade, an amount of pressure, and so forth. Example information indicative of weather characteristics may include an ambient temperature, an ambient temperature, an ambient humidity, and so forth.

At block 930, in response to determining that the determined angle of attack is equal to or substantially equal to the target angle of attack, the computer system 800 maintains the angle of attack of the screed plate 316 (e.g., by maintaining the position of the screed system 108).

At block 934, in response to determining that the determined angle of attack is different than (e.g., above or below) the target angle of attack, the computer system 800 is configured to actuate the hydraulic cylinder 120 to reposition the screed system 108 (and therefore the screed plate 316). For example, in response to determining that the determined angle of attack is larger than the target angle of attack (e.g., the screed plate 316 is tipped too far towards a back of the screed system 108), the computer system 800 may be configured to actuate the hydraulic cylinder 120 to lower a front of the screed system 108 to decrease the angle of attack. In another example, in response to determining that the determined angle of attack is smaller than the target angle of attack (e.g., the screed plate 316 is tipped too far towards a front of the screed system 108), the computer system 800 may be configured to actuate the hydraulic cylinder 120 to raise the front of the screed system 108. In some aspects of the disclosure, the computer system 800 may activate the indicator 336 in response to determining that the determined angle of attack is different than the target angle of attack. In some aspects of the disclosure, the operator I/O interface 115 may display the determined angle of attack of the screed plate 316 in real time or in substantially real time.

Alternatively, in some aspects of the disclosure, the computer system 800 may operate the indicator 336 to signal that the determined angle of attack is different than the target angle of attack. In such aspects, the operator may actuate the hydraulic cylinder 120, via the operator I/O interface 115, to reposition the screed system 108 so that the determined angle of attack is the same as or substantially the same as the target angle of attack.

In some aspects of the disclosure, blocks 912-918 may occur simultaneously with blocks 922-934. In some aspects of the disclosure, blocks 922-934 may occur before blocks 912-198.

In some aspects of the disclosure, the computer system 800 may be configured to record the pressure distribution and/or the determined angle of attack during operation of the road paver 100 along a paving route. The computer system 800 may then determine target angles of attack for the paving route. For example, the computer system 800 may associate target angles of attack for certain GPS coordinates or ranges of GPS coordinates along the paving route. In some aspects of the disclosure, the computer system 800 may be configured to receive information indicative of the surface to be paved along the paving route, and determine target angles of attack for the paving route based on the information indicative of the surface to be paved along the paving route. Example information indicative of the surface to be paved may include a grade of the surface, a curvature of the surface to be paved, a material of the surface to be paved, predicted or actual ambient temperature, predicted or actual humidity, and so forth, for certain GPS coordinates or range of GPS coordinates along the paving route.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps, and decision steps.

### Illustrative Embodiments

An example screed system includes a screed plate and a plurality of pressure sensors coupled to the screed plate and configured to sense a pressure of the screed plate.

In some aspects, the plurality of pressure sensors of the screed system of paragraph [0059] is configured to determine one or more of a pressure at a center of the screed plate, at a first side of the screed plate, and at a second side of the screed plate. The second side is opposite the first side.

In some aspects, the screed system of paragraph further includes at least one actuator configured to change an angle of attack the screed plate in response to a sensed pressure of the screed plate. The angle of attack is an angle between the screed plate and a surface to be paved.

In some aspects, the screed system of paragraph includes a first screed unit including the screed plate and a second screed unit including a second screed plate. At least a height of the first screed unit is adjustable relative to a height of the second screed unit.

Another example system includes a screed plate, a plurality of pressure sensors coupled to the screed plate and configured to sense pressure information of the screed plate, and a controller configured to determine a pressure distribution across the screed plate based on the sensed pressure information and generate a screed plate repositioning control signal based on the determined pressure distribution.

In some aspects, the screed plate repositioning control signal of the system of paragraph [0063] is configured to automatically and dynamically reposition the screed plate based on the determined pressure distribution.

In some aspects, the system of paragraph further includes an operator input/output device configured to display the information indicative of a status of the screed plate that includes the determined pressure distribution and further configured to receive an operator input/output instruction and generate the repositioning signal to reposition the screed plate.

In some aspects of the system of paragraph [0065], the information indicative of the status of the screed plate further includes one or more of an indication that the screed plate should be repositioned, an illustration of actual pressures determined by plurality of pressure sensors, an animation illustrating the pressure distribution across the screed plate, an indication that the determined pressures are within a predefined range, and an indication that the screed plate should be repositioned.

In some aspects, the system of paragraph further includes an actuator configured to reposition the screed plate in response to the screed plate repositioning control signal by changing an angle of attack of the screed plate. The angle of attack is an angle between the screed plate and a surface to be paved.

In some aspects, the controller of the system of paragraph is further configured to determine an amount of variance across the determined pressure distribution and change the angle of attack of the screed plate to reduce the amount of variance across the determined pressure distribution.

In some aspects, the controller of the system of paragraph is further configured to compare the determined pressure distribution to a target pressure distribution and change the angle of attack of the screed plate to bring the determined pressure distribution closer to the target pressure distribution in response to the comparison.

In some aspects, the controller of the system of paragraph is further configured to compare the angle of attack of the screed plate to a target angle of attack and change the angle of attack is adjusted in response to the comparison.

In some aspects of the system of paragraph [0070], the target angle of attack is determined based on one or more of a target road grade, information indicative of a grade of the surface to be paved, a type of paving material, desired characteristics of the paved surface, information indicative of weather characteristics during the paving operation, and a pattern of the screed plate.

In some aspects, the controller of the system of paragraph is configured to dynamically reposition the screed plate in real-time based on the determined pressure distribution.

In some aspects, the system of paragraph further includes a first screed unit including the screed plate and a second screed unit including a second screed plate. At least a height of the first screed unit is adjustable relative to a height of the second screed unit. The controller is further configured to determine, based on a determined pressure distribution of the screed plate, that the height of the first screed unit is likely different than the height of the second screed unit and adjust the height of the first screed unit so that the first screed unit is similar to the height of the second screed unit.

An example computer-implemented method for positioning a screed system configured to engage a road paver includes: receiving pressure information from a plurality of pressure sensors engaged with a screed plate; determining a pressure distribution across the screed plate based on the sensed pressure information; determining, based on the determined pressure distribution across the screed plate, an angle of attack of the screed plate, wherein the angle of attack is an angle between the screed plate and a surface to be paved; and dynamically adjusting the angle of attack of the screed plate based on the determined pressure distribution.

In some aspects, the computer-implemented method of paragraph includes determining an amount of variance across the determined pressure distribution, and commanding an actuator to adjust the angle of attack of the screed plate to reduce the amount of variance across the determined pressure distribution.

In some aspects, the computer-implemented method of paragraph includes comparing the determined pressure distribution to a target pressure distribution and commanding an actuator to adjust the angle of attack of the screed plate to bring the determined pressure distribution closer to the target pressure distribution in response to the comparison.

In some aspects, the computer-implemented method of paragraph includes determining that at least a portion of the determined pressure distribution exceeds a target pressure distribution and displaying, via an operator input/output device, an notification indicating that pressure in at least a portion of the screed plate exceeds the target pressure distribution.

In some aspects, the computer-implemented method of paragraph [0074], includes comparing the angle of attack of the screed plate to a target angle of attack and commanding an actuator to adjust the angle of attack in response to the comparison.

In some aspects, the computer-implemented method of paragraph includes determining the target angle of attack based on one or more of a target road grade, information indicative of a grade of the surface to be paved, a type of paving material, desired characteristics of the paved surface, information indicative of weather characteristics during the paving operation, and a pattern of the screed plate.

In some aspects, the screed system includes a first screed unit including the screed plate and a second screed unit including a second screed plate, and at least a height of the first screed unit is adjustable relative to a height of the second screed unit. In such aspects, the computer-implemented method of paragraph includes determining, based on the determined pressure distribution, that the height of the first screed unit is likely different than the height of the second screed unit and adjusting the height of the first screed unit so that the first screed unit is similar to the height of the second screed unit.

In some aspects, the computer-implemented method of paragraph includes dynamically repositioning the screed plate in real-time based on the determined pressure distribution.

What is claimed is:

1. A screed system comprising:
a screed plate; and
a plurality of pressure sensors coupled to the screed plate and configured to sense a pressure of the screed plate.

2. The screed system of claim 1, wherein the plurality of pressure sensors is configured to determine one or more of a pressure at a center of the screed plate, at a first side of the screed plate, and at a second side of the screed plate, the second side opposite the first side.

3. The screed system of claim 1, further comprising at least one actuator configured to change an angle of attack the screed plate in response to a sensed pressure of the screed plate, wherein the angle of attack is an angle between the screed plate and a surface to be paved.

4. The screed system of claim 1, wherein the screed system includes a first screed unit including the screed plate and a second screed unit including a second screed plate, and wherein at least a height of the first screed unit is adjustable relative to a height of the second screed unit.

5. A system including:
a screed plate;
a plurality of pressure sensors coupled to the screed plate and configured to sense pressure information of the screed plate; and
a controller configured to:
determine a pressure distribution across the screed plate based on the sensed pressure information; and
generate a screed plate repositioning control signal based on the determined pressure distribution.

6. The system of claim 5, wherein the screed plate repositioning control signal is configured to automatically and dynamically reposition the screed plate based on the determined pressure distribution.

7. The system of claim 5, further comprising an operator input/output device configured to display the information indicative of a status of the screed plate that includes the determined pressure distribution and further configured to receive an operator input/output instruction and generate the repositioning control signal to reposition the screed plate.

8. The system of claim 7, wherein the information indicative of the status of the screed plate further includes one or more of an indication that the screed plate should be repositioned, an illustration of actual pressures determined by plurality of pressure sensors, an animation illustrating the pressure distribution across the screed plate, an indication that the determined pressures are within a predefined range, and an indication that the screed plate should be repositioned.

9. The system of claim 5, further comprising an actuator configured to reposition the screed plate in response to the screed plate repositioning control signal by changing an angle of attack of the screed plate, wherein the angle of attack is an angle between the screed plate and a surface to be paved.

10. The system of claim 9, wherein the controller is further configured to:
determine an amount of variance across the determined pressure distribution; and
change the angle of attack of the screed plate to reduce the amount of variance across the determined pressure distribution.

11. The system of claim 9, wherein the controller is further configured to:
compare the determined pressure distribution to a target pressure distribution; and
change the angle of attack of the screed plate to bring the determined pressure distribution closer to the target pressure distribution in response to the comparison.

12. The system of claim 9, wherein the controller is further configured to:
compare the angle of attack of the screed plate to a target angle of attack; and
change the angle of attack is adjusted in response to the comparison.

13. The system of claim 12, wherein the target angle of attack is determined based on one or more of a target road grade, information indicative of a grade of the surface to be paved, a type of paving material, desired characteristics of the paved surface, information indicative of weather characteristics during the paving operation, and a pattern of the screed plate.

14. The system of claim 5, wherein the controller is configured to dynamically reposition the screed plate in real-time based on the determined pressure distribution.

15. The system of claim 5, wherein the system further comprises:
a first screed unit including the screed plate; and
a second screed unit including a second screed plate, wherein at least a height of the first screed unit is adjustable relative to a height of the second screed unit;
wherein the controller is further configured to:
determine, based on a determined pressure distribution of the screed plate, that the height of the first screed unit is likely different than the height of the second screed unit; and
adjust the height of the first screed unit so that the first screed unit is similar to the height of the second screed unit.

16. A computer-implemented method for positioning a screed system configured to engage a road paver, the method comprising:
receiving pressure information from a plurality of pressure sensors engaged with a screed plate;
determining a pressure distribution across the screed plate based on the sensed pressure information;
determining, based on the determined pressure distribution across the screed plate, an angle of attack of the screed plate, wherein the angle of attack is an angle between the screed plate and a surface to be paved; and
dynamically adjusting the angle of attack of the screed plate based on the determined pressure distribution.

17. The computer-implemented method of claim 16, the method including:
determining an amount of variance across the determined pressure distribution; and
commanding an actuator to adjust the angle of attack of the screed plate to reduce the amount of variance across the determined pressure distribution.

18. The computer-implemented method of claim 16, the method including:
comparing the determined pressure distribution to a target pressure distribution; and
commanding an actuator to adjust the angle of attack of the screed plate to bring the determined pressure distribution closer to the target pressure distribution in response to the comparison.

19. The computer-implemented method of claim 16, the method including:
determining that at least a portion of the determined pressure distribution exceeds a target pressure distribution; and
displaying, via an operator input/output device, an notification indicating that pressure in at least a portion of the screed plate exceeds the target pressure distribution.

20. The computer-implemented method of claim 16, the method including:
comparing the angle of attack of the screed plate to a target angle of attack; and
commanding an actuator to adjust the angle of attack in response to the comparison.

21. The computer-implemented method of claim 20, further comprising determining the target angle of attack based on one or more of a target road grade, information indicative of a grade of the surface to be paved, a type of paving material, desired characteristics of the paved surface, information indicative of weather characteristics during the paving operation, and a pattern of the screed plate.

22. The computer-implemented method of claim 16, wherein the screed system includes a first screed unit including the screed plate and a second screed unit including a second screed plate, and wherein at least a height of the first screed unit is adjustable relative to a height of the second screed unit, and wherein the method includes:
determining, based on the determined pressure distribution, that the height of the first screed unit is likely different than the height of the second screed unit; and
adjusting the height of the first screed unit so that the first screed unit is similar to the height of the second screed unit.

23. The computer-implemented method of claim 16, the method including dynamically repositioning the screed plate in real-time based on the determined pressure distribution.
